(19) United States
(12) Patent Application Publication
(10) Pub. No.: US 2011/0078182 A1
(43) Pub. Date: Mar. 31, 2011

(54) SYSTEMS AND METHODS FOR GENERATING A LIST OF VEHICLES AND FOR PROVIDING INSTRUCTIONS FOR LOADING STORAGE SPACE

(75) Inventors: Peter A. Fenyes, Bloomfield Hills, MI (US); John A. Cafeo, Farmington, MI (US); Qi D. Van Eikema Hommes, West Bloomfield, MI (US); Artemis Kloess, Rochester Hills, MI (US); Srinivasan Rajagopalan, Troy, MI (US); Jian Tu, Shanghai (CN)

(73) Assignee: GM GLOBAL TECHNOLOGY OPERATIONS, INC.

(21) Appl. No.: 12/567,924

(22) Filed: Sep. 28, 2009

(51) Int. Cl. G06F 17/30

(52) U.S. Cl. 707/770

(57) ABSTRACT

Systems and methods for providing instructions for loading objects into a storage space and for generating an optimized list of vehicles. The methods include generating a list of objects including receiving an object characteristic, retrieving an object based on the object characteristic, and receiving a selection of a retrieved object. The methods further include retrieving dimensional data associated with objects and retrieving dimensional data associated with a storage space of a vehicle.

### TECHNICAL FIELD

This disclosure relates generally to systems and methods for generating a list of vehicles and for providing instructions for loading storage space.

### BACKGROUND

In many instances, users have a number of objects that need to be loaded into vehicle storage space but cannot figure out how the objects need to be arranged to fit in the storage space. In other instances, the users need to find a vehicle or container in which the objects can be suitably loaded. Each of these activities is increasingly difficult where the objects are irregularly shaped. What is needed are systems and methods for facilitating each of these activities.

### SUMMARY

The various embodiments of the present disclosure overcome the shortcomings of the prior art by providing systems and methods for generating an optimized list of vehicles and for providing instructions for loading storage space. The systems and methods described herein can be used to facilitate purchasing or renting a vehicle, purchasing or renting an auxiliary storage container, and loading a vehicle or auxiliary storage container.

According to an exemplary embodiment, a computer-implemented method for providing instructions for loading objects into a vehicle includes, at a central application server, generating a list of objects to be loaded into the vehicle, retrieving dimensional data associated with each object in the list, retrieving dimensional data for storage space associated with the vehicle, determining an arrangement in which objects in the list can be loaded into the storage space, and communicating to the user communication device instructions for loading the objects into the storage space to achieve the arrangement. Generating a list of objects to be loaded into the vehicle includes receiving an object characteristic from a communication device associated with a user where the user communication device is separate from the central application server, communicating to the user communication device an object search result associated with the object characteristic, receiving from the user a selection of an object search result, and including the selected object search result in the list.

According to an exemplary embodiment, a computer-implemented method for generating an optimized list of vehicles includes, at a central application server, generating a list of objects to be loaded into a vehicle, retrieving dimensional data associated with each object in the list, retrieving dimensional data for storage space associated with each vehicle identified in an initial list of vehicles, determining which of the vehicles in the initial list have storage space that is suitable for loading with the objects in an arrangement, and generating the optimized list from at least one suitable vehicle. Generating a list of objects to be loaded into a vehicle includes receiving an object characteristic from a communication device associated with a user where the user communication device is separate from the central application server, communicating to the user communication device an object search result associated with the object characteristic, receiving from the user a selection of an object search result, and including the selected object search result in the list.

The foregoing has broadly outlined some of the aspects and features of the present disclosure, which should be construed to be merely illustrative of various potential applications. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE VIEWS OF THE DRAWINGS

FIG. 1 is a schematic illustration of a system, according to an exemplary embodiment of the disclosure.

FIGS. 2 and 3 are diagrams of methods performed by the system of FIG. 1, according to an exemplary embodiment of the disclosure.

FIGS. 4, 5, and 7 are illustrations of a communication device of the system of FIG. 1.

FIG. 6 is an illustration of a group of objects.

FIGS. 8-12 are illustrations of objects and a storage space of a vehicle, according to an exemplary embodiment of the disclosure.

### DETAILED DESCRIPTION

As required, detailed embodiments are disclosed herein. It must be understood that the disclosed embodiments are merely exemplary and that other embodiments in various and alternative forms, and combinations thereof, are within the scope of the teachings of the disclosure. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods being known to those of ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Exemplary systems and methods described herein are configured to provide information to help a user select a vehicle or other container with storage space that can be loaded with a group of objects. Further, exemplary systems and methods described herein are configured to provide instructions for loading storage space with a group of objects. The systems and methods described herein can be used to facilitate purchasing or renting a vehicle, purchasing or renting an auxiliary storage container, and loading a vehicle when traveling with luggage or when moving.

As used herein, the term “storage space” is used to generally describe storage space associated with a vehicle or other container and includes one or more compartments or areas in which objects can be loaded. Exemplary storage space of a vehicle includes spaces and compartments that are integral to a vehicle (trunk, glove box, truck bed, hatch space, passenger compartments, and the like) and spaces and compartments of auxiliary containers (trailer, roof-top carrier, and the like) that attach to or are associated with a vehicle. For purposes of teaching, the systems and methods are described with respect to the trunk of a vehicle although the systems and methods are similarly applicable to other storage space including any of, or any combination of, spaces and compartments described above. Further, beyond vehicle applications the disclosed systems and methods are applicable to other structures with storage space such as the auxiliary containers by themselves.

One advantage of the systems and methods described herein is that the user does not have to enter dimensional information or dimensional data associated with an object or storage space. Rather than requiring the user to specify the dimensions of such objects or storage space, the systems and methods described herein are configured to locate, access, and retrieve dimensional data of objects and storage space. For example, the user can simply search for an object or vehicle with an associated storage space and the system will locate, access, and retrieve the dimensional data. Thus, with the systems and methods described herein, the user can easily and conveniently obtain the dimensional details of such objects or storage space even where objects or storage space are irregularly shaped. Otherwise, dimensional details of irregularly shaped objects and storage space are relatively complicated and difficult to enter or obtain. Complex dimensional details may be expressed best as dimensional data generated with a computer aided drafting (CAD) software application. In general, dimensional data for irregularly shaped objects or storage space can be stored as CAD files, stereolithography files, voxelization files, combinations thereof, and the like.

For purposes of teaching, an irregular shape is that which cannot have its shape approximated simply by specifying a few basic dimensions such as height, width, length, radius, diameter, and the like. Regular shapes include boxes, cuboids, cones, pyramids, cylinders, etc. Further, irregularly shaped objects and storage spaces can include those with dimensions that do not vary predictably along a dimension of the object or storage space, such as objects and storage spaces having convex regions, concave regions, holes, combinations thereof, and the like.

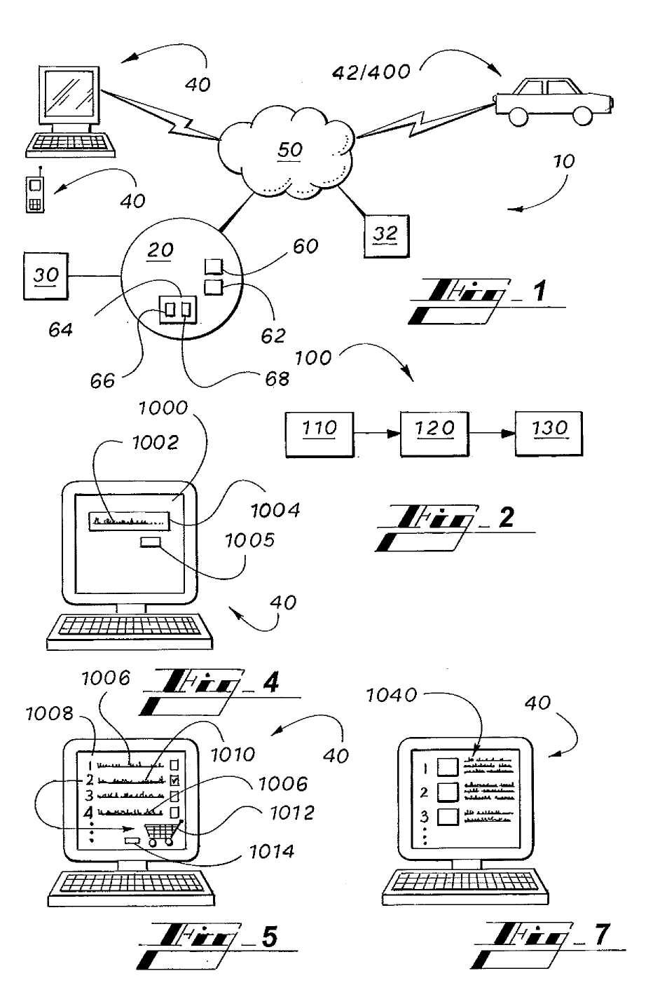

Referring to FIG. 1, an exemplary system 10 is configured to perform a method of generating a list of objects and a list of one or more vehicles into which the objects can be loaded. The system 10 is also configured to perform a method of generating and delivering instructions for loading the objects into storage space of a particular vehicle. Certain of the elements of the illustrated system 10 are remotely located with respect to one another. The illustrated system 10 includes an application server 20, databases 30, 32, and communication devices 40, 42 with user interfaces. The illustrated databases 30, 32 and communication devices 40, 42 are connected to the application server 20 via the internet 50, via an intranet, or via a direct connection.

The illustrated system 10 is provided for purposes of teaching exemplary methods associated with FIGS. 2 and 3 and described in further detail below. The illustrated system 10 can be modified, for example, according to the following: the number and types of connections between the elements can be modified, the number and types of elements can be modified, the function of each element can be modified, combinations thereof, and the like.

Generally described, the application server 20 is configured to receive user input from the communication devices 40, 42 through the user interfaces, to retrieve dimensional data from the databases 30, 32, to optimize the loading of one or more vehicles according to dimensional data, to generate instructions for loading a vehicle, and to optimize a list of candidate vehicles. To accomplish these and other functions, the application server 20 includes software modules 60, 62, 64, 66, 68. For example, programming languages such as C, C++, C#, Java, JavaScript, Peri, PHP, Python, Ruby, and SQL can be used to write the software modules. The inputting software module 60 is configured to receive input though the communication devices 40, 42 and to transmit output to the communication devices 40, 42. The retrieving software module 62 is configured to access and retrieve dimensional data from databases 30, 32. The outputting software module 64 is configured to process dimensional data according to an algorithm and to transform the results of the algorithm into information that is useful to a user. To transform the results of the algorithm, the outputting software module 64 includes the optimizing software module 66 that generates an optimized list of vehicles and the instructing software module 68 that generates instructions for loading a vehicle.

The local database 30 is a resource that is directly connected to the application server 20 and stores data that is central to the system 10. The remote database 32 is an example of one of multiple resources that is not necessarily affiliated with the application server 20 but is connected or accessible to the application server 20 via the Internet 50. For example, the remote database 32 stores data on a third party website or a merchant website. As used herein, the term “database” includes, but is not limited to data sources, data stored on hard drives, websites, remote servers, other sources of information that are accessible through the internet, combinations thereof, and the like. The system 10 is configured to determine the best resource to search for a particular type of object or vehicle.

Communication devices can include a personal computer, a hand-held mobile communication device, a smart phone, a Personal Digital Assistant (PDA), a laptop computer, a vehicle computer, a vehicle communication device, combinations thereof, and the like. A vehicle communication device such as those used with OnStar® and the like can provide automatic communication whereas other communication devices are user operated. According to exemplary embodiments described herein, a user can view and submit data through the user interface of the communication device 40, 42 which accesses a website produced by the application server 20. For example, the communication device 40, 42 is configured with a web browser that can load the website produced by the application server 20. In alternative embodiments, a graphical user interface (GUI) may be provided as part of an application at least partially local to the communication device 40, 42.

Referring to FIG. 2, an exemplary method 100 that is performed by the system 10 is described. The method 100 includes an input step 110 performed by the software modules 60, 62, a processing step 120 performed by the outputting software module 64, and an output step 130 performed by the software modules 60, 64. The input step 110, the processing step 120, and the output step 130 are now described in detail.

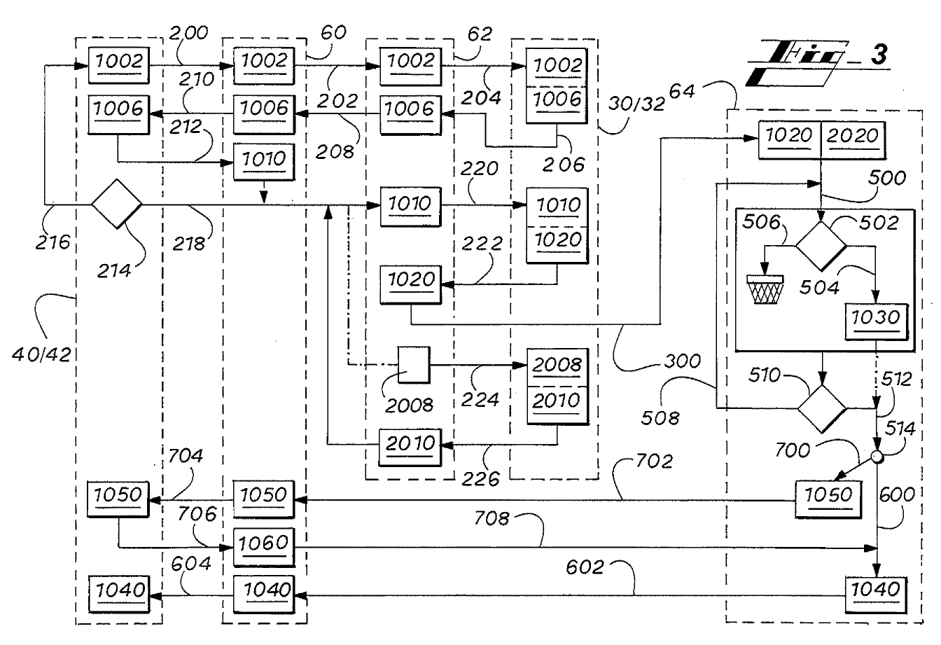

Referring to FIGS. 2 and 3, the input step 110 includes a number of exemplary substeps for receiving user inputs and retrieving dimensional data for each of a group of objects 410 and for storage space 402 of one or more vehicles 400 (see objects 410 illustrated in FIG. 6 and trunk 402 of vehicle 400 illustrated in FIG. 8). Referring to FIGS. 3 and 4, according to a step 200, the inputting software module 60 receives user inputs. Through a website 1000 on the communication device 40, the inputting software module 60 prompts the user to identify one of the objects 410. Specifically, the inputting software module 60 displays a text entry box 1004 into which a user enters one or more object characteristics 1002 that identify an object 410. Characteristics or identifiers of an object or vehicle include names, associated keywords, tags, categories, Universal Product Code (UPC) bar codes, brands, models, makes, sizes, classes, types, sources (store, rental agency, location, dealer, maker, and the like), vehicle identification numbers (VIN), OnStar® addresses, IP addresses, authentication credentials (user login, private/public keys, and the like), combinations thereof, and the like. Characteristics can be alternatively indicated by checking boxes, clicking successively refined icons, selecting from dropdown menus, combinations thereof, and the like. Referring momentarily to FIG. 4, the user submits the entered object characteristics 1002 by clicking a submit button 1005 and the inputting software module 60 receives the object characteristics 1002.

Referring again to FIG. 3, according to a step 202, the inputting software module 60 confirms that the object characteristics 1002 are sufficient for retrieving object search results 1006 and then transfers the object characteristics 1002 to the retrieving software module 62. According to steps 204, 206, the retrieving software module 62 determines whether the descriptions of the object search results 1006 can be found in the local database 30 or if the object search results 1006 must be retrieved from partner resources or unaffiliated but freely accessible resources represented by the remote database 32. The system 10 is configured to access resources in order of any of a predetermined preference, reliability, cost, download speed, efficiency, combinations thereof, and the like. In the illustrated embodiment, the retrieving software module 62 accesses and retrieves object search results 1006 from database 30 and, if necessary, additionally accesses and retrieves object search results 1006 from database 32. The retrieving software module 62 searches and retrieves object search results 1006 such as names, descriptions, and images that are associated with the object characteristics 1002 and that are sufficient to identify dimensional data 1020. As such, object search results 1006 identify objects in a specific manner and each object search result 1006 is linked to specific dimensional data 1020, as described in further detail below.

The retrieving software module 62 is configured to search external resources such as database 32 with techniques including searching resources for keywords, dimensions, and file extensions. The order for searching the external resources can be ranked based on probability of finding the data in the resource. The resources to be searched may be determined with a ranking algorithm, predetermined, random, determined based on past results, combinations thereof, and the like. The search history can be saved to make previous search results easy to find again and retrieved data can be stored by the system 10 and linked to the search history. Each of these steps makes return visits to the system 10 by the user or other users more efficient.

Referring to FIGS. 3 and 5, according to steps 208, 210, the retrieving software module 62 transfers the object search results 1006 to the inputting software module 60 and the inputting software module 60 displays the object search results 1006 on a web page 1008 on the communication device 40. According to a step 212, inputting software module 60 prompts the user to narrow or confirm the object search results 1006 and adds the selected object search result 1010 to a cart 1012 or otherwise stores or flags the selected object search result 1010. Object search results 1006 may be one search result if the user input was specific enough, in which case the user merely confirms that the retrieving software module 62 retrieved the correct object search result 1006 corresponding to an object 410.

At a decision step 214, the inputting software module 60 prompts the user to confirm that the selected object search results 1010 in the cart 1012 represent the group of objects 410. In other words, the software module 60 prompts the user to confirm that all of the objects 410 have been identified to the system 10. If not, according to a step 216, the inputting software module 60 prompts the user to identify another object beginning with the step 200. If so, the user clicks a submit button 1014 to confirm that the inputting software module 60 has received all the selected object search results 1010.

The inputting software module 60 prompts the user to identify the state of the objects 410. For example, the state of the objects can be packaged, unpackaged, assembled, unassembled, and the like. For any such objects 410, the dimensional data 1020 retrieved for the associated selected object search result 1010 will reflect the state.

According to a step 218, the inputting software module 60 makes available the selected object search result 1010 to the retrieving software module 62. The retrieving software module 62 determines if the dimensional data of the selected object search result 1010 can be found in the local database 30 or the remote database 32. According to steps 220, 222 the retrieving software module 62 searches the appropriate database 30, 32 and retrieves dimensional data 1020 corresponding to each of the selected object search result 1010.

Once selected object search results 1010 are identified and dimensional data 1020 is retrieved (or being retrieved), the user may limit the universe of vehicles that are to be considered by the system 10. For example, the universe of vehicles can be limited to the user's vehicle or vehicles, vehicles with a certain brand or type (SUV, minivan, etc.), vehicles that a rental company offers, availability of rental vehicles, vehicles with a certain passenger capacity, combinations thereof, and the like.

According to an exemplary method, the inputting software module 60 prompts the user to create a list that includes one or more vehicles 400. The list of vehicles is created in substantially the same manner in which the list of objects was created according to the substeps of the input step 110 illustrated in FIG. 3. Element numbers that represent vehicle data moving through the input step 110 begin with a “2” as opposed to the element numbers that represent object data moving through the input step 110 which begin with “1”. For clarity, the vehicle data element numbers are not illustrated for the input step 110. Rather, each vehicle data element number can be associated with a corresponding object data element number. For example, vehicle characteristics 2002 can be associated with object characteristics 1002.

Again referring to FIG. 3 and FIG. 5, according to the step 200, the inputting software module 60 prompts the user to enter one or more vehicle characteristics 2002 that identify a vehicle 400 into the text entry box 1004 of the website 1000. The inputting software module 60 receives the vehicle characteristics 2002 as the user submits the vehicle characteristics 2002 by clicking the submit button 1005. According to the step 202, the inputting software module 60 determines whether the vehicle characteristics 2002 are sufficient to retrieve vehicle search results 2006 and, if so, transfers the vehicle characteristics 2002 to the retrieving software module 62. Each of the vehicle search results 2006 represents a vehicle 400 and is linked to dimensional data 2020 for the storage space 402 of the vehicle 400. According to steps 204, 206, based on the vehicle characteristics 2002, the retrieving software module 62 determines where vehicle search results 2006 that match the vehicle characteristics 2002 can be found and searches and retrieves the vehicle search results 2006 from the corresponding databases 30, 32.

According to the steps 208, 210, the retrieving software module 62 transfers the vehicle search results 2006 to the inputting software module 60 and the inputting software module 60 displays the vehicle search results 2006 to the user through the communication device 40. According to the step 212, the inputting software module 60 prompts the user to select from the vehicle search results 2006 and the inputting software module 60 adds a selected vehicle search result 2010 to the cart 1012 or otherwise stores or flags the selected vehicle search result 2010. At decision step 214, the inputting software module 60 prompts the user to decide if each desired vehicle 400 is represented by a selected vehicle search result 2010 in the cart 1012. If not, according to the step 216, the inputting software module 60 prompts the user to repeat the vehicle identification process beginning with step 200. If so, the inputting software module 60 prompts the user to submit the selected vehicle search results 2010 in the cart 1012 by clicking the submit button 1014.

According to a step 218, the inputting software module 60 transfers the selected vehicle search results 2010 to the retrieving software module 62. According to the steps 220, 222, the retrieving software module 62 determines where the dimensional data 2020 associated with each selected vehicle search result 2010 can be found and retrieves the dimensional data 2020 from the corresponding database 30, 32.

As mentioned previously, the dimensional data 2020 is that of the storage space 402 of the selected vehicle search result 2010. In certain cases, vehicles 400 have a storage space 402 that includes multiple spaces or compartments or have a storage space 402 that can be configured into different shapes and volumes. Here, dimensional data for each space, compartment, and configuration associated with a selected vehicle search result 2010 is retrieved. A user can be prompted to select one or more spaces, compartments, and configurations to define the storage space 402 of a vehicle 400. In sum, storage space of the vehicle 400 can be considered the compilation of spaces and compartments selected by the user.

In alternative embodiments, the user is not prompted to create the list of vehicles. Rather, the list of vehicles is predetermined and stored in the database 30, 32. Referring to FIG. 3, at step 218, once the user clicks the submit button 1014 to submit selected object search results 1010 to the retrieving software module 62, the inputting software module 60 is configured to initiate instructions 2008 that instruct the retrieving software module 62 to access and retrieve the list of vehicles 2010 from the database 30, 32 according to steps 224, 226. The dimensional data 2020 for the list of vehicles 2010 is then retrieved as in steps 220, 222. This embodiment is applicable, for example, where a list of vehicles 2010 is available through and provided by a certain rental car company. The user can be prompted to narrow the list of vehicles 2010 retrieved by the retrieving software module 62 according to various criteria prior to retrieving dimensional data 2020 according to steps 220, 222.

Referring again to FIGS. 2 and 3, once dimensional data 1020, 2020 for a group of objects 410 and for vehicles 400 have been collected according to the input step 110, the dimensional data 1020, 2020 is processed according to the processing step 120. Referring to FIG. 3, according to a step 300, the dimensional data 1020, 2020 is transferred to the outputting software module 64 by the retrieving software module 62. During the processing step 120, the outputting software module 64 analyzes the dimensional data 1020, 2020 of the objects 410 and of the storage spaces 402 according to an exemplary algorithm, which may be programmed into outputting software module 64. In general, the algorithm determines whether it is possible and how to optimally load the group of objects 410 into the storage space 402 of each vehicle 400.

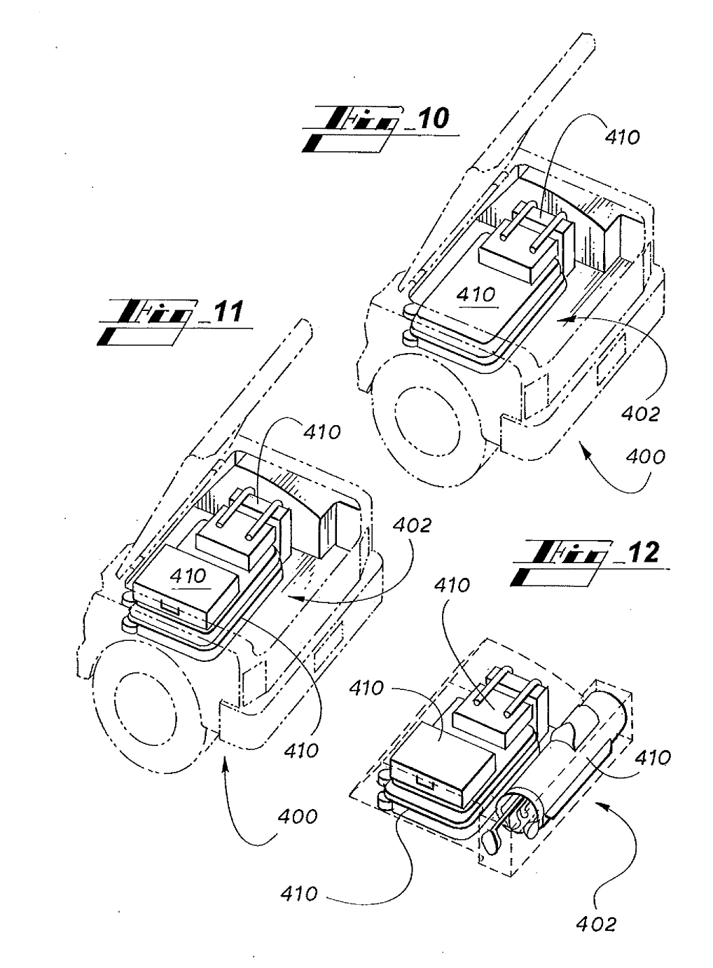

Referring to FIGS. 3, 6, and 8-12, according to a step 500 where the dimensional data 1020, 2020 is combined according to an exemplary algorithm, a storage space 402 of a vehicle 400 is selected, each object 410 is given a randomly generated orientation (the coordinate axes XYZ of the object 410 relative to the coordinate axes XYZ of the storage space 402), and each object 410 is virtually loaded into the selected storage space 402 according to a randomly generated order. In this embodiment, the order that the objects 410 are loaded into the storage space 402 corresponds to the positions of the objects 410 in the storage space 402 as the objects 410 are loaded according to a bottom-left-back progression. The bottom-left-back position of the storage space 402 is substantially at the origin of the associated coordinate axis shown in FIG. 8.

At a decision step 502, the dimensions of the resulting arrangement of the group of objects 410 is compared to the dimensions of the storage space 402. If the dimensions of the resulting arrangement of the group of objects 410 fits within the dimensions of the storage space 402 or otherwise doesn't interfere with the boundaries of the storage space 402, the arrangement of objects 410 is accepted and the corresponding arrangement information 1030 (order, position, orientation, and the like) is stored by the outputting software module 64 according to a step 504. If the dimensions of the resulting arrangement of the group of objects 410 does not fit within the dimensions of the storage space 402 or otherwise interferes with the boundaries of the storage space 402, the arrangement of the group of objects 410 is rejected by the outputting software module 64 according to a step 506. In the illustrated embodiment, this process can be repeated according to a step 508 with other randomly generated arrangements.

As used herein, the process of “determining an arrangement” is considered to be determining at least one arrangement.

Where an acceptable arrangement of the group of objects 410 is not found for the storage space 402, the algorithm is configured to automatically repeat this process with a subset of the group of objects 410 beginning at step 500. According to one embodiment, the user is prompted to remove one or more objects 410 from consideration. Alternatively or additionally, the user is prompted to add a compartment or space to the current storage space 402.

The algorithm may factor in other data corresponding to each object 410 such as the weight data, compressibility data, fragility data, stability data, combinations thereof and the like. Such data can be used in optimizing randomly generated arrangements of objects 410 or in limiting the position, orientation, or location of certain objects 410. Arrangements can also be optimized for efficiency or compactness.

According to a decision step 510, a step 512 is performed after the step 508 is performed for a certain number of iterations and at least one acceptable arrangement has been found. The step 512 gathers the information saved at step 504 and proceeds toward a next step where the information is organized so as to be useful to the user.

Alternatively, step 512 can be performed once an acceptable arrangement of objects 410 is found, proceeding without completing all iterations. Here, step 508 is performed at decision step 510 until an acceptable arrangement of objects 410 is found.

A cycle or set of iterations is performed for storage space 402 of each vehicle 400.

According to an exemplary optimization method, an optimal arrangement of objects 410 is found by using arrangement information 1030 from previously found acceptable arrangements of objects 410 to facilitate selecting the next random orientation, sequence, and/or loading of the objects 410 into the storage space 402. For example, arrangement information 1030 from preferred arrangements (according to a certain preference rule) can be used to converge to tightly packed arrangements of objects 410. Here, arrangements of objects 410 with higher preference are made to be more likely to be selected when generating subsequent arrangements of objects 410. For such a method, each step 508 can include gathering arrangement information 1030.

Referring again to FIGS. 2 and 3, in the output step 130, the results of the processing step 120 are transformed or organized and output to the user. For purposes of teaching, the illustrated output step 130 includes a decision step 514 where the user is prompted to make a decision as to what information is desired. However, in certain embodiments, the desired output information is known or predetermined and the decision step 514 can be omitted along with one of the methods of information organization described in further detail below.

An exemplary method that is performed by the instructing software module 68 is now described. For purposes of teaching, the method is described with respect to a single vehicle 400. According to a step 600, the user is prompted by the inputting software module 60 to select the file or output format of the instructions or the hardware with which the instructions will be accessed. For example, the user may select a personal computer with the instructions in text, html, .doc, or .pdf, audio, image, video formats, or other formats associated with software of particular hardware or communications devices. The instructing software module 68 generates loading instructions 1040 for loading the storage space 402 of the vehicle 400. The loading instructions are in the desired format and based on the arrangement information 1030, including the orientation, location, and order associated with an accepted or optimal arrangement of objects 410. Where multiple acceptable arrangements are found, the arrangements can be compared at step 600 to determine an optimal arrangement of objects 410 before generating the loading instructions 1040.

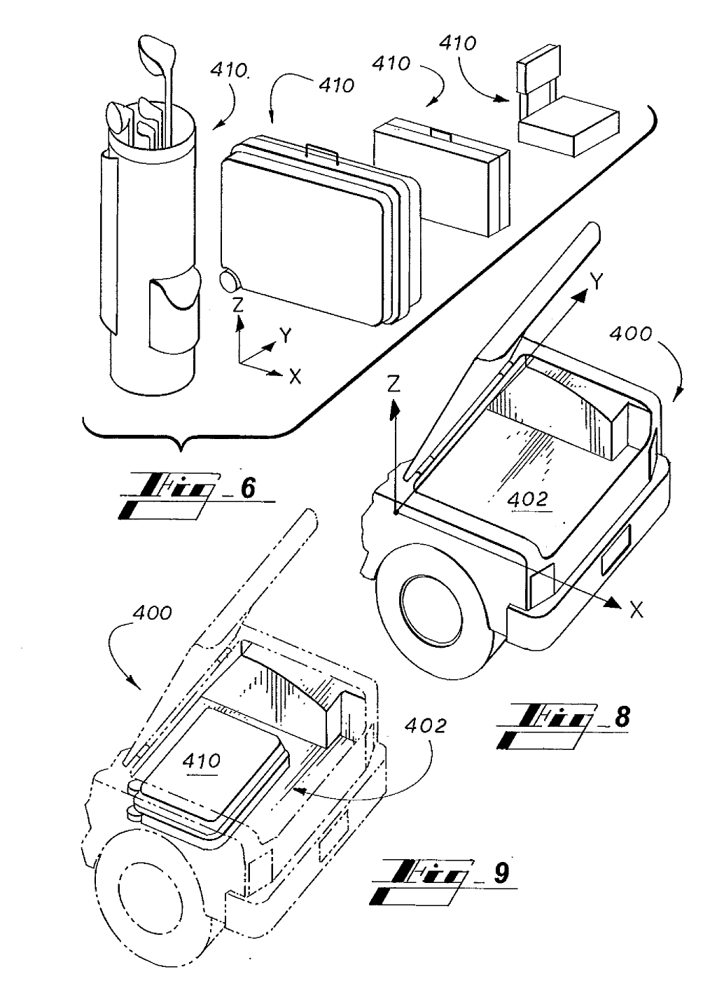

In the illustrated embodiment, the loading instructions 1040 are transferred to the inputting software module 60, according to a step 602, which then communicates the instructions to the user through the communication device 40, according to a step 604 and illustrated in FIG. 7.

An exemplary method that is performed by the optimizing software module 66 is now described. The exemplary method is described with respect to a plurality of vehicles 400. According to a step 700, the optimizing software module 66 compiles and optimizes a list of vehicles 1050 for which an accepted arrangement of the group of objects 410 has been found. The optimizing software module 66 is configured to optimize the list of vehicles 1050, for example, according to various user preferences and to list the vehicles 400 in order from most optimal to least optimal.

The optimized list of vehicles 1050 is transferred to the inputting software module 60, according to a step 702, which then displays the list of vehicles 1050 for a user through the communication device 40, according to a step 704. According to steps 706, 708, the user can select one of the vehicles 400 from the list of vehicles 1050 and get instructions for loading the group of objects 410 in the storage space 402 of the selected vehicle 1060 beginning with the step 600 of the exemplary method described above.

For purposes of illustration, exemplary applications of the systems and methods are described. According to a first exemplary application where a user desires to load a vehicle 400 with a group of objects 410, the user identifies both the vehicle 400 and the objects 410 to the system 10 through the communication device 40 as described above. The desired output is instructions 1040 in html format. Accordingly, the output to the communication device 40 is a web page displaying loading instructions 1040 for loading the vehicle 400. The loading instructions 1040 can also include steps for configuring the storage space 402 of the vehicle 400, where applicable. For example, a seat may have to be removed or reconfigured.

Here, the loading instructions 1040 include written instructions accompanied by visual representations of the written instructions. In alternative embodiments, the loading instructions 1040 include a pictorial or movie representation of the loading instructions that may be viewed as a virtual three dimensional representation on the communication device 40.

In the exemplary application, the loading instructions 1040 are printed and taken with the user to the vehicle 400. Alternatively, the loading instructions 1040 may be saved to an attached mobile device or sent to and displayed on a mobile device with an Internet, cellular, or other wireless connection. Such mobile devices include OnStar®, eNav®, GPS devices, digital cameras, cell phones, smart phones, iPOD®s, PDAs, and the like.

According to a second exemplary application, a user desires to receive loading instructions 1040 through a vehicle communication device 42 with operator service (such as OnStar®). In this case, the vehicle 400 to be loaded is the vehicle 400 that is equipped with the vehicle communication device 42. Through the vehicle communication device 42, the user tells the operator what objects 410 are desired to be loaded into the vehicle 400. The operator identifies the objects to the system 10 through the communication device 40, as previously described, and the vehicle communication device 42 automatically identifies the vehicle 400 to the system 10. The system 10 generates loading instructions 1040 and outputs the loading instructions 1040 in a format that can be communicated by the vehicle communication device 42. For example, the loading instructions 1040 can be delivered to a driver information center, to the navigation (NAV) screen, or to a monitor in the vehicle 400. The format of the loading instructions 1040 can be text, a three dimensional visual of loaded objects 410, a three dimensional exploded visual of loaded objects 410, or a three dimensional movie depicting the loading of the objects 410. Alternatively, the loading instructions 1040 can be verbalized by the operator.

According to a third exemplary application, a user desires to find a rental vehicle or a new vehicle 400 in which a group of objects 410 can be loaded. The user identifies the objects 410 to the system 10. The rental vehicles or new vehicles 400 in consideration can be pulled from a database 30, 32 or supplied by the user through the communication device 40, as described above. The output of the system 10 is a list of vehicles 1050 that are capable of being loaded with the group of objects 410. The user can search or narrow the list of vehicles 1050 according to certain preferences and make a selection from the list of vehicles 1050. Making a selection can involve getting additional information, making a purchase, and making a rental reservation.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A computer-implemented method for providing instructions for loading objects into a vehicle, comprising:
at a central application server:
generating a list of objects to be loaded into the vehicle, comprising:
receiving an object characteristic from a communication device associated with a user, wherein the user communication device is separate from the central application server;
communicating to the user communication device an object search result based on the object characteristic;
receiving from the user a selection of an object search result; and
including the object associated with the selected object search result in the list;
retrieving dimensional data associated with each object in the list;
retrieving dimensional data for storage space associated with the vehicle;
determining an arrangement in which objects in the list can be loaded into the storage space; and
communicating to the user communication device instructions for loading the objects into the storage space to achieve the arrangement.

2. The method of claim 1, wherein generating a list of objects to be loaded into the vehicle further comprises:
accessing an object database to locate an object search result associated with the object characteristic; and
retrieving the object search result from the object database.

3. The method of claim 2, wherein generating a list of objects to be loaded into the vehicle further comprises prompting a user to select an additional object characteristic to eliminate a retrieved object search result.

4. The method of claim 2, wherein the object database is separate from the central application server.

5. The method of claim 4, wherein the object database is a merchant web site.

6. The method of claim 1, further comprising receiving a vehicle characteristic for identifying the vehicle.

7. The method of claim 6, wherein the vehicle characteristic is a unique identifier that indicates a particular make, model, and model year.

8. The method of claim 6, wherein receiving a vehicle characteristic comprises receiving the vehicle characteristic from a vehicle communication system associated with the vehicle.

9. The method of claim 6, further comprising:
communicating to the user communication device a vehicle search result that corresponds to the vehicle characteristic; and
receiving from the user a selection of a vehicle search result.

10. The method of claim 9, further comprising:
accessing a vehicle database to locate a vehicle search result associated with vehicles having the vehicle characteristic; and
retrieving the vehicle search result from the vehicle database.

11. The method of claim 10, further comprising prompting the user to select an additional vehicle characteristic to eliminate a retrieved vehicle search result.

12. The method of claim 10, wherein the vehicle database is separate from the central application server.

13. The method of claim 1, wherein the storage space is a composite of one or more compartments associated with the vehicle.

14. The method of claim 1, wherein communicating to the user communication device instructions for loading the objects comprises communicating the arrangement including the order, location, and orientation associated with each object.

15. The method of claim 1, wherein determining an arrangement in which the objects in the list can be loaded into the storage space comprises selecting an optimal one of a plurality of possible arrangements.

16. The method of claim 1, wherein retrieving dimensional data associated with each object search result in the list comprises receiving from the user an indication of the state of each selected object search result.

17. A computer-implemented method for generating an optimized list of vehicles, comprising:
at a central application server:
generating a list of objects to be loaded into a vehicle, comprising:
receiving an object characteristic from a communication device associated with a user, wherein the user communication device is separate from the central application server;
communicating to the user communication device an object search result associated with the object characteristic;
receiving from the user a selection of an object search result; and
including an object associated with the selected object search result in the list;
retrieving dimensional data associated with each object in the list;
retrieving dimensional data for storage space associated with each vehicle identified in an initial list of vehicles;
determining which of the vehicles in the initial list have storage space that is suitable for loading with the objects in an arrangement; and
generating the optimized list from the suitable vehicles.

18. The method of claim 17, further comprising retrieving the initial list of vehicles from a vehicle database.

19. The method of claim 17, further comprising generating the initial list of vehicles by:
receiving a vehicle characteristic from the communication device associated with a user, wherein the user communication device is separate from the central application server;
communicating to the user communication device a vehicle search result associated with the vehicle characteristic;
receiving from the user a selection of a vehicle search result; and
including a vehicle associated with the selected vehicle search result in the initial list.

20. The method of claim 17, wherein generating a list of objects to be loaded into a vehicle further comprises:
accessing an object database to locate an object search result associated with the object characteristic; and
retrieving the object search result from the object database.
